(19) United States
(12) Patent Application Publication
(10) Pub. No.: US 2003/0145072 A1
(43) Pub. Date: Jul. 31, 2003

(54) Auto-discovery of network configuration

(76) Inventors: Richard C. Lau, Morganville, NJ (US); Frank C.D. Tsai, Morganville, NJ (US); Arturo Cisneros, Lincroft, NJ (US)

Correspondence Address: David M. Rosenblatt, Esq., Telcordia Technologies, Inc., 445 South Street 1G112R, Morristown, NJ, 07960, US

(21) Appl. No.: 10/062,700

(22) Filed: Jan. 31, 2002

(51) Int. Cl. G06F 15/173

(52) U.S. Cl. 709/223

(57) ABSTRACT

Methods and apparatus are provided to determine the configuration of a network such as its topology. Based on status information received from nodes in the network, respective labels that indicate one or more virtual connections traversing the nodes are determined. Based on the determined labels, one or more links connecting the nodes are identified. The configuration of the network is then determined based on the identified links.

### CROSS REFERENCE TO RELATED APPLICATIONS

This application is related to U.S. Application Ser. No.______, entitled “Virtual Network Configuration Verification,” filed concurrently with the present application.

### FIELD OF THE INVENTION

The present invention relates to communication networks and, in particular, to methods and apparatus for discovering information about the topology of a network.

### BACKGROUND OF THE INVENTION

In networks, especially large networks, it is difficult to accurately determine the current configuration of a network. Determining the configuration of a network typically involves understanding the arrangement of nodes in the network. Having accurate information about the configuration of a network may be important for planning, testing, and trouble-shooting of the network.

One aspect of configuration is the topology of a network. The topology of a network may change frequently as nodes are added, removed, modified, and upgraded. The topology may also change when links connecting the nodes in the network are added or removed.

Conventionally, a network administrator must manually track these and other changes to the configuration. Unfortunately, manual tracking is cumbersome and prone to errors and becomes increasingly difficult as the size of a network increases. This frequently causes the network configuration to become unclear for long periods of time until the manual tracking methods catch up with the network conditions.

It is therefore desired to provide methods and apparatus that overcome these and other shortcomings of the prior art.

### SUMMARY OF THE INVENTION

Accordingly, methods and apparatus are provided to determine configuration of at least a portion of a network. Based on status information from nodes in the portion of the network, respective labels that indicate one or more virtual connections traversing the nodes are determined. At least one link, such as between two nodes in a subset of the nodes, is identified based on the respective labels. The configuration of the portion of the network is then determined based on the identified link.

In accordance with another aspect of the present invention, methods and apparatus are provided to determine a configuration of a node in a network. Based on status information from the node and at least one other node in the network, respective labels that indicate one or more virtual connections traversing the node are determined. At least one link between the node and the other node is identified based on the respective labels. The configuration of the node is then determined based on the identified link.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

In the Figures:

FIG. 1 illustrates a system, in accordance with methods and apparatus consistent with the present invention;

FIG. 2 illustrates a block diagram of a server, in accordance with methods and apparatus consistent with the present invention;

FIG. 3 illustrates a block diagram of a node, in accordance with methods and apparatus consistent with the present invention;

FIG. 4 illustrates a table in a configuration database, which a server uses to identify one or more links between nodes, in accordance with methods and apparatus consistent with the present invention; and

FIG. 5 illustrates the steps that a server may perform to determine a configuration of a network, in accordance with methods and apparatus consistent with the principles of the present invention.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

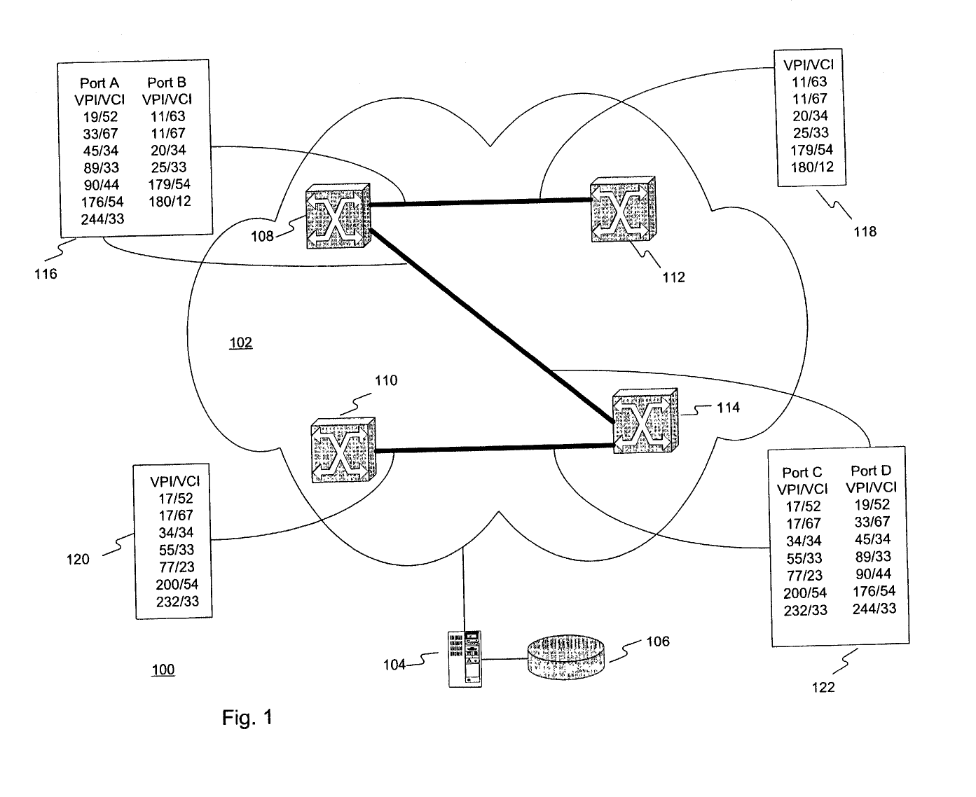

FIG. 1 illustrates a system 100, in accordance with methods and apparatus consistent with the principles of the present invention. As shown, system 100 comprises a network 102, a server 104, and a configuration database 106. Network 102 may include an interconnected group of nodes capable of sharing information. Network 102 may include, for example, a wide area network (WAN), or a local area network (LAN). Network 102 may be implemented using a variety of technologies alone or in combination, including wireline technologies, such as, telephone, fiber optic cables, etc., and wireless technologies, such as, radio frequency (RF), satellite, microwave. Furthermore, network 102 may support a variety of protocols including Internet Protocols (IP), Asynchronous Transfer Mode (ATM), Frame-Relay, etc.

Network 102 may include nodes 108, 110, 112, and 114 that serve as points of connection. Although FIG. 1 illustrates four nodes inside network 102, any number of nodes may be interconnected across network 102, including nodes external to network 102. Nodes 108, 110, 112, and 114 may be implemented as a switch, or router.

Nodes 108, 110, 112, and 114 may include cross-connect tables 116, 118, 120, and 122, respectively. Cross-connect tables 116, 118, 120, and 122 indicate virtual connections traversing nodes 108, 110, 112, and 114, respectively. A virtual connection refers to any type of logical connection traversing a node, such as an IP multiprotocol label switching (“MPLS”) label switched path, an ATM virtual circuit, or a Frame-Relay virtual circuit. For example, cross-connect tables 116, 118, 120, and 122 are shown storing information indicating ATM virtual connections each having labels based on a virtual path identifier (“VPI”) and a virtual channel identifier (“VCI”). However, one skilled in the art would understand that cross-connect tables 116, 118, 120, and 122 may be modified to accommodate other types of communications, such as a MPLS label switched path, or Frame-Relay virtual circuit.

Nodes 108, 110, 112, and 114 may be interconnected by one or more links, where a link may include a path, either physical or logical, that defines a specific communication channel or circuit between one or more nodes. A physical link may relate to the electrical and mechanical components embodying the communications channel or circuit. A logical link may be viewed as an abstraction of one or more underlying physical links representing the connectivity, between two nodes. The physical and logical links between nodes 108, 110, 112, and 114 may be based on the respective physical and logical topologies. A physical topology of network 102 corresponds to a representation of the physical links. A logical topology of network 102 is an abstract representation based upon the logical links. Configuration information for network 102 may include any information indicating the physical topology or logical topology of network 102.

Server 104 may provide operations support for network 102, such as for configuration management, provisioning, testing, billing, monitoring, and other management functions. Server 104 may be implemented as a general-purpose computer using known hardware and software.

Configuration database 106 may store for information relating to the configuration of network 102, such as information relating to the physical and logical topologies of network 102. Configuration database 106 may be implemented using known hardware and software, such as the ORACLE product family provided by Oracle Corporation, the DB2 product family provided by International Business Machines (“IBM”) Corporation, or products from the Sybase Corporation. Although shown directly connected to server 104, configuration database 106 may be integrated with server 104, or may be remotely connected across a network to server 104.

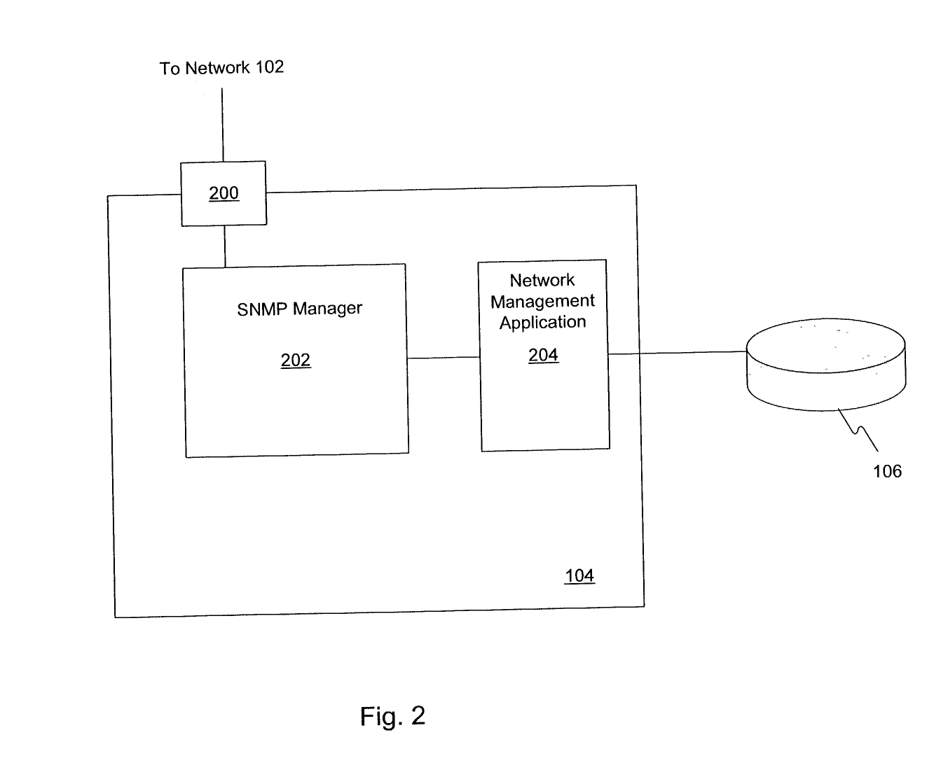

FIG. 2 illustrates a block diagram of server 104, in accordance with methods and apparatus consistent with the principles of the present invention. Server 104 may comprise an I/O port 200, a Simple Network Management Protocol (SNMP) manager 202, and a network management application 204. I/O port 200 may provide an interface to network 102. Although server 104 is shown with one I/O port, any number of ports may be implemented.

SNMP manager 202 may poll and interpret status information from nodes 108, 110, 112, and 114. In one embodiment, SNMP manager 202 may use the SNMP protocol to access status information, such as Management Information Base (“MIB”) parameters from nodes 108, 110, 112, and 114. RFC-1157, J. Case et al., “A Simple Network Management Protocol (SNMP),” (1990), describes, inter alia, the SNMP protocol and a MIB and is incorporated herein by reference in its entirety. For example, SNMP manager 202 may query, get responses, set variables, and acknowledge information to and from nodes 108, 110, 112, and 114 using the following SNMP operations: get(); get next(); get response(); set(); and trap(). SNMP manager 202 may use the “get” operation to retrieve status information. SNMP manager 202 may use the “get next” operation to iteratively retrieve a series of status information messages from cross-connect tables 116, 118, 120, and 122 over a series of SNMP messages. The “get response” operation may be used to respond to a “get” operation. SNMP manager 202 may use the “set” operation to alter a variable or parameter in nodes 108, 110, 112, and 114. The “trap” operation allows either SNMP manager 202 or nodes 108, 110, 112, and 114 to specify an SNMP event in response to an alarm condition.

Alternatively, SNMP manager 202 may use other network management schemes alone or in combination with the SNMP protocol. For example, SNMP manager 202 may use IP utilities, such as pings, traceroutes, and zone transfers. In addition, SNMP manager 202 may use ATM operations and maintenance (“OAM”) cells. Furthermore, proprietary schemes from particular manufacturers may also be incorporated into SNMP manager 202.

Network management application 204 may provide analysis functions based on the status information, such as, MIB parameters received by SNMP manager 202. Functions supported by network management application 204 may include one or more of the following: providing topology maps of network 102; a user interface to interact with nodes 108, 110, 112, and 114; various displays indicating the status of nodes 108, 110, 112, and 114; and a compiling function used in conjunction with configuration database 106 to store and access MIB parameters. Network management application 204 may be implemented using known software, such as the NETVIEW product family provided by IBM Corporation, or the OPENVIEW product family from the Hewlett Packard (“HP”) Company. Although FIG. 2 shows one network management application, one skilled in the art would understand that multiple network management applications and SNMP managers may be implemented in a single server or across multiple servers coupled together.

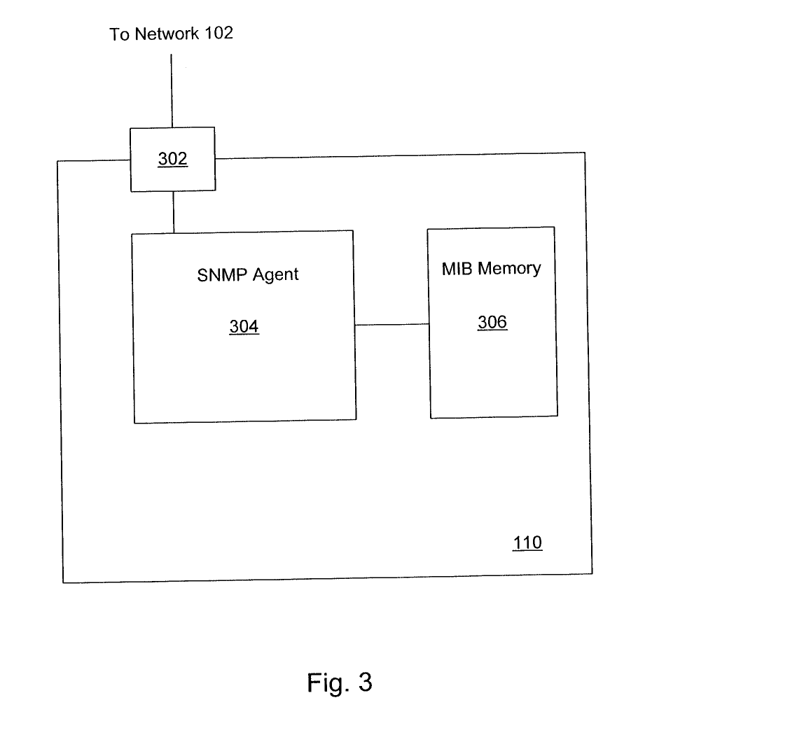

FIG. 3 illustrates a block diagram of node 110, in accordance with the methods and apparatus consistent with the principles of the present invention. As shown, node 110 may comprise an I/O port 302, an SNMP agent 304, and a MIB memory 306.

I/O port 302 may provide an interface to network 102. Although node 110 is shown with one I/O port, any number of ports may be implemented. In addition, node 110 may include a management port (not shown) to send and receive status information, such as SNMP protocol messages.

SNMP agent 304 may maintain and provide status information for node 110. For example, SNMP agent 304 may perform one or more of the following: retrieve and store MIB parameters in MIB memory 308; respond to queries from SNMP agent 202; and provide information in response to an event such as an alarm condition. SNMP agent 304 may also allow node 110 to act as a proxy for another node. When acting as a proxy, node 110 may use non-SNMP communications such as proprietary messages to communicate with the other node. Upon receiving the status information from the other node, node 110 may then translate and forward this status information in the form of SNMP protocol communications. SNMP agent 304 may be implemented using known software and hardware.

MIB memory 306 may store status information, such as MIB parameters collected by SNMP agent 304. A wide variety of information may be stored in MIB memory 306 including information, such as cross-connect tables; address information of communications traversing node 110; error counts; and on/off status. MIB memory 306 may also store other types of status information, such as traffic statistics for node 110.

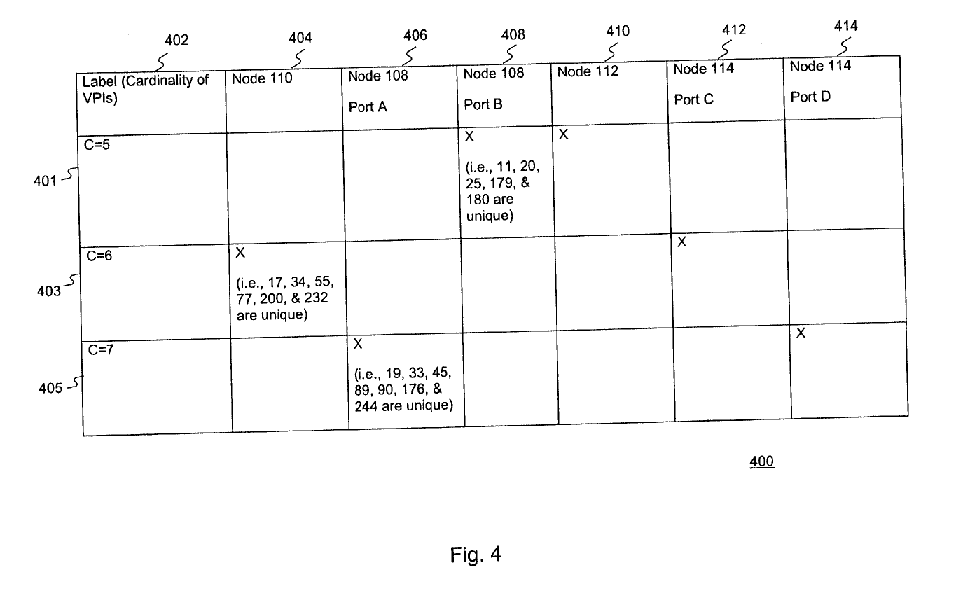

FIG. 4 illustrates a table 400 in configuration database 106, which server 104 may use to identify one or more links between nodes. As shown, table 400 may comprise rows 401, 403, and 405 and columns 402, 404, 406, 408, 410, 412, and 414. Column 402 may include a label, such as a “cardinality,” to indicate virtual connections traversing a node. A cardinality may refer to a value representing a quantity, such as the number of unique virtual path identifiers (“VPI”) found in a portion of a cross-connect table for a node. In particular, table 400 may comprise rows 401, 403, and 405 to indicate cardinality values of 5, 6, and 7, respectively.

Column 404 may include an indicator to note the cardinality associated with node 110. For example, based on information in cross-connect table 120, node 110 may support virtual connections having VPIs of 17, 17, 34, 55, 77, 200, and 232. Of these VPIs, there are six unique values (i.e., since the VPI value 17 repeats), and hence, node 110 may have a cardinality of 6. Similarly, columns 406, 408, 410, 412, and 414 may also indicate respective cardinalities of nodes 110, 112, and 114. As shown in FIG. 4, node 108 may have cardinalities of 7 and 5 (i.e., since node 108 has two ports). Node 112 may have a cardinality of 5 and node 114 has cardinalities of 6 and 7 (i.e., since node 114 also has two ports).

Alternatively, table 400 may include labels other than a cardinality. For example, table 400 may include labels based upon virtual path identifiers (VPI) or virtual channel identifier (VCI) for ATM virtual connections, a data link connection identifier (“DLCI”) for Frame-Relay virtual connections, or MPLS labels for IP MPLS label switched paths. Any label that identifies a virtual connection traversing a node may also be used.

In addition, table 400 may also include a portion of cross-connect tables 116, 118, 120, and 122. For example, server 104 may scroll through a portion of cross-connect tables 116, 118, 120, and 122 to determine the configuration of network 102. The size of the portion may be predetermined, such as 256 entries, or may vary as the configuration of network 102 is discovered. The entries in each of the portions of cross-connect tables 116, 118, 120, and 122 may then be compared to determine the configuration of network 102.

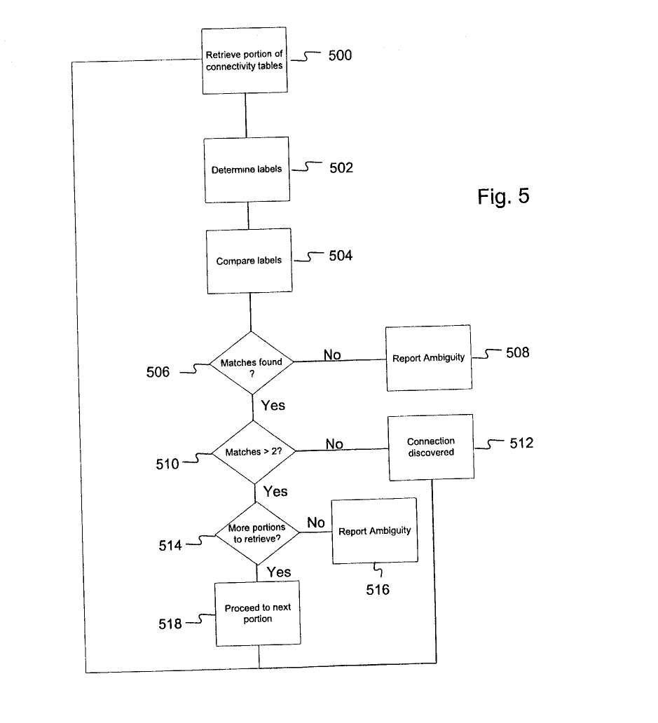

FIG. 5 illustrates the steps that server 104 may perform to determine a configuration of network 102, in accordance with methods and apparatus consistent with the principles of the present invention. In one embodiment, server 104 retrieves portions of cross-connect tables 116, 118, 120, and 122 from nodes 108, 110, 112, and 114, respectively (stage 500). For example, SNMP manager 202 may use a series of “get next” operations to query nodes 108, 110, 112, and 114 for their respective cross-connect tables 116, 118, 120, and 122. Nodes 108, 110, 112, and 114 may then reply using “get response” messages. SNMP manager 202 may provide this information to network management application 204, which may then compile the portions of cross-connect tables 116, 118, 120, and 122 into table 400.

Network management application 204 may determine respective labels for each virtual connection traversing nodes 108, 110, 112, and 114 (stage 502). For example, as described in detail with respect to FIG. 4, network management application 204 may calculate respective cardinalities for nodes 108, 110, 112, and 114 based on information compiled in table 400.

Network management application 204 may compare the respective labels across the rows of table 400 to determine which of nodes 108, 110, 112, and 114 are interconnected by links (stage 504). Network management application 204 may then determine the number of label matches found in table 400 (stage 506). For example, as shown in FIG. 4, network management application 204 may determine matches based on respective cardinalities. Alternatively, network management application 204 may determine matches by directly comparing virtual connection labels, such as virtual path identifiers (VPI) or virtual channel identifiers (VCI) for ATM virtual connections, a data link connection identifier (“DLCI”) for Frame-Relay virtual connections, or MPLS labels for IP MPLS label switched paths.

If no matches are found, then network management application 204 may report a possible configuration ambiguity (stage 508). For example, network management application 204 may report that the current portion of cross-connect tables 116, 118, 120, and 122 are 0, nodes 108, 110, 112, and 114 are not connected to each other, or nodes 108, 110, 112, and 114 are misconfigured.

If matches are found, then network management application 204 may determine whether the number of matches exceeds a threshold value, such as a two matches (stage 510). If the numbers of matches do not exceed the threshold value, then network management application 204 may identify a link between the corresponding nodes (stage 512). For example, based on the respective cardinalities shown in table 400, node 108 may have links to nodes 112 and 114, and node 110 may have a link to node 114. In addition, network management application 204 may then indicate these links in configuration database 206.

If the number of matches exceeds a threshold value, such as two matches, then network management application 204 may determine whether more portions of cross-connect tables 116, 118, 120, and 122 may be retrieved (stage 514). If there are not more portions of cross-connect tables 116, 118, 120, and 122, which may be retrieved, then network management application 204 may report an ambiguity (stage 516). For example, network management application 204 may assume that a link connects two nodes and, thus, may interpret more than two matches to be a configuration ambiguity.

If there are more portions of cross-connect tables 116, 118, 120, and 122, which may be retrieved, network management application 204 may then cause server 104 to proceed to subsequent portions of connectivity tables 116, 118, 120, and 122 and conduct a next iteration beginning again at stage 500 to resolve the ambiguity.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method to determine a configuration of at least a portion of a network, the method comprising:
receiving status information relating to nodes in the portion of the network;
determining, for the nodes, respective labels that indicate one or more virtual connections traversing the nodes based on the status information;
identifying at least one link between a subset of the nodes based on the respective labels; and
determining the configuration of the portion of the network based on the at least one link.

2. The method of claim 1, wherein receiving status information comprises:
receiving management information base parameters from the nodes.

3. The method of claim 2, wherein receiving the management information base parameters comprises receiving a virtual path identifier for each of the one or more virtual connections.

4. The method of claim 2, wherein receiving the management information base parameters comprises receiving virtual channel identifier information for each of the one or more virtual connections.

5. The method of claim 1, wherein determining respective labels that indicate one or more virtual connections traversing the nodes comprises determining one or more identifiers for each of the one or more virtual connections.

6. The method of claim 5, wherein determining at least one link between the subset of the nodes comprises determining the subset of nodes having the same one or more identifiers.

7. The method of claim 5, wherein determining one or more identifiers comprises determining a virtual path identifier for each of the one or more virtual connections.

8. The method of claim 7, wherein determining one or more identifiers comprises determining a virtual channel identifier for each of the one or more virtual connections.

9. The method of claim 1, wherein determining respective labels that indicate one or more virtual connections traversing the nodes comprises:
determining a number of the virtual connections traversing the nodes; and
determining respective cardinalities of the nodes based on the number of the virtual connections.

10. The method of claim 9, wherein determining at least one link between the subset of the nodes comprises determining the subset of nodes having the same cardinality.

11. The method of claim 10, further comprising receiving additional status information when the subset of nodes exceeds a threshold number of nodes.

12. The method of claim 11, wherein the threshold number of nodes is 2.

13. An apparatus, comprising:
means for receiving status information relating to nodes in at least a portion of a network;
means for determining respective labels for the nodes that indicate one or more virtual connections traversing the nodes based on the status information;
means for identifying at least one link between a subset of the nodes based on the respective labels; and
means for determining a configuration of the portion of the network based on the at least one link.

14. The apparatus of claim 13, wherein the means for receiving status information comprises:
means for receiving management information base parameters relating to the plurality of nodes.

15. The apparatus of claim 14, wherein the means for receiving the management information base parameters comprises means for receiving virtual path identifier for each of the one or more virtual connections.

16. The apparatus of claim 14, wherein the means for receiving the management information base parameters comprises means for receiving virtual channel identifier information for each of the one or more virtual connections.

17. The apparatus of claim 13, wherein the means for determining respective labels that indicate one or more virtual connections traversing the nodes comprises means for determining one or more identifiers for each of the one or more virtual connections.

18. The apparatus of claim 17, wherein the means for determining at least one link between the subset of the nodes comprises means for determining the subset of nodes having the same one or more identifiers.

19. The apparatus of claim 17, wherein the means for determining one or more identifiers comprises means for determining a virtual path identifier for each of the one or more virtual connections.

20. The apparatus of claim 17, wherein the means for determining one or more identifiers comprises means for determining a virtual channel identifier for each of the one or more virtual connections.

21. The apparatus of claim 13, wherein the means for determining respective labels that indicate one or more virtual connections traversing the nodes comprises:
means for determining a number of the virtual connections traversing the nodes; and
means for determining respective cardinalities of the nodes based on the number of the virtual connections.

22. The apparatus of claim 21, wherein the means for determining at least one link between the subset of the nodes comprises means for determining the subset of nodes having the same cardinality

23. The apparatus of claim 22, further comprising means for receiving additional status information when the subset of nodes exceeds a threshold number of nodes.

24. The apparatus of claim 23, wherein the threshold number of nodes is 2.

25. A method for determining a configuration of a node in a network, the method comprising:
receiving status information relating to the node and at least one additional node in the network;
determining respective labels that indicate one or more virtual connections traversing the node based on the status information;
identifying at least one link between the node and the at least one additional node based on the respective labels; and
determining a configuration of the node based on the at least one link.

26. An apparatus, comprising:
means for receiving status information relating to a node in a network and at least one additional node in the network;
means for determining respective labels that indicate one or more virtual connections traversing the node based on the status information;
means for identifying at least one link between the node and the at least one additional node based on the respective labels; and
means for determining a configuration of the node based on the at least one link.
